(19) United States
(12) Patent Application Publication
(10) Pub. No.: US 2026/0015837 A1
(43) Pub. Date: Jan. 15, 2026

(54) DUAL-FUNCTION SHOWER APPARATUS

(71) Applicant: Globe Union Industrial Corp., Taichung City (TW)

(72) Inventors: Chu-Cheng Chu, Taichung City (TW); Chun-Hung Li, Taichung City (TW); Chun-Yi Tu, Taichung City (TW); Meng-Chun Yen, Taichung City (TW)

(21) Appl. No.: 19/097,818

(22) Filed: Apr. 1, 2025

(30) Foreign Application Priority Data
Jul. 10, 2024 (CN) 2024216289275

(51) Int. Cl. E03C 1/02; B05B 1/18; E03C 1/04

(52) U.S. Cl. CPC E03C 1/023; B05B 1/18; E03C 1/0409

(57) ABSTRACT

A dual-function shower apparatus including a diverter, a fixed shower, a fixing bracket, and a handheld shower is provided. The diverter allows water to flow in and switch water flow. The fixing shower is connected to the diverter and provided with a mounting recess and a trough opening formed on a bottom wall. The fixing bracket includes first and second connection portions respectively fixed on the diverter and mounted to the trough opening. The handheld shower is communicating with the diverter and having a shower head. A part of the shower head is mounted in the mounting recess and having a fixing base on a rear side for detachably connection to the second connection portion. Thereby both the fixed shower and the handheld shower provide sufficient amount of water and spray area. The handheld shower is easily detached or installed. The fixing bracket is easily replaced with lower cost.

### FIELD OF THE INVENTION

The present invention relates to a shower apparatus, especially to a dual-function shower apparatus.

### BACKGROUND OF THE INVENTION

Both an overhead shower and a handheld shower are common shower apparatuses used in bathrooms. Each of them with its own advantages and shortcomings can meet all users' shower needs. In most cases, such as in consideration of installation cost, the user only selects one of the showers to install in the bathroom. Once the user has different shower needs, both the overhead shower and the handheld shower are installed in the bathroom. However, the installation of the two showers significantly increases cost and complexity of installation. At the same time, a larger space for installation is required.

Refer to U.S. Pat. No. 10,017,923 B2, a shower assembly is provided. The shower assembly includes a base and a handheld shower. The base is a fixed spray head with a recessed area and a spray portion around the recessed area. A plurality of first apertures is disposed on the spray portion to generate a spray of water within a bathing area. The handheld shower having a moveable spray head and a handle extending from the moveable spray head. The moveable spray head is held within the recessed area of the base and fixed on the base by magnets or clips. Users can remove the moveable spray head by applying force to the handle. A water supply provides water to the base and the handheld shower through a water supply tube with a diverter.

The fixed spray head of the base defines a slot which tapers from a wider end portion to a narrower end portion. The movable spray head similarly tapers from a wider end portion to a narrower end portion. Thus the moveable spray head of the handheld shower is received in the slot. In another structure, the slot tapered from a wider end portion to a narrower end portion is located under the recessed area (at a bottom edge of the base) so that the moveable spray head is received in the recessed area. As to the tapered handle, it is slid and received in the slot.

In the above patent, the handheld shower is detachably mounted or docked to a base. The base works like the conventional overhead shower while the handheld shower allows users to direct water flow. Thus the users can use either the base for rain shower or move the handheld shower to change directions of spray of water.

Although the device in the above prior art provides dual-function shower apparatus, it's design still has certain shortcomings. For example, the handheld shower and the base are overlapped quite a lot no matter in order to ensure that the moveable spray head of the handheld shower is firmly secured in the recessed area or the slot of the base, or the moveable spray head of the handheld shower is fixed in the slot tapered from the wider end portion to the narrower end portion. Thus the handheld shower occupies quite a lot space and area of the base so that the rest area of the base able to be used for arrangement of the spray portion is significantly reduced. As shown in related figures, it is obvious that the spray portion is only able to be arranged at a narrow C-shaped area or a tight area on two sides of the slot. Such design causes some problems. One of the problems is that the area of the spray portion is insufficient so that no adequate amount of water sprayed or the spray area is provided. Thereby user's needs for a good shower cannot be met. The area of the spray portion can be increased by increasing the volume of the base. Yet such solution not only increases the cost but also the weight. Thus a loading on the support is increased and the aesthetic appearance is affected. Although reduction of the volume of the moveable spray head leaves more area for arrangement of the spray portion, the amount of the water or the spray area of the handheld shower is decreased.

Moreover, the handheld shower is mounted and locked in the recessed area or the slot of the base by its outline, or magnetic parts. Yet during assembly or user's taking process, a bit swung such as tilting horizontally or vertically may lead to locking or interference between the outline and the recessed area or the slot. Thus the assembly or disassembly is not smooth.

Furthermore, as to the design of the handheld shower being directly fixed on the base, the base needs to be replaced once a fixing member on the base such as a clip is damaged. Besides higher cost for replacement of the base, connections between flow channels and other parts are also involved so the replacement are more complicated and users cannot replace the base easily by themselves.

### SUMMARY

Therefore, it is a primary object of the present invention to provide a dual-function shower apparatus which includes a fixed shower and a handheld shower respectively providing different shower modes—an overhead bath and a handheld shower bath, and allowing users to select according to their demands. The handheld shower can be removed or installed easily, without obstruction or interference from the fixed shower. At the same time, the fixed shower and the handheld shower both supply sufficient amount of water coming out of the shower and spray area to meet various needs of the users. The handheld shower is designed to be fixed on a fixing bracket which is easy to replace and maintain and having advantage of low replacement cost.

In order to achieve the above object, a dual-function shower apparatus according to the present invention includes a diverter, a fixed shower, a fixing bracket, and a handheld shower.

The diverter is directly or indirectly fixed on a wall and able to be operated for directing water flowing through to a first water outlet or a second water outlet.

The fixed shower consists of a water inlet joint located at a back side and used for connection with the first water outlet, an internal cavity communicating with the water inlet joint, a spray panel located at a front side and communicating with the internal cavity, and a mounting recess located at a first side of the spray panel. The mounting recess is provided with a first notch formed at the first side, a bottom wall, a trough opening formed on the bottom wall and located at the first side, and a second notch formed on the trough opening and located at the first side. A width of the second notch is smaller than a width of the first notch.

The fixing bracket is provided with a first connection portion and a second connection portion connected to the first connection portion. The first connection portion is for connection to the diverter and the second connection portion is mounted to the trough opening of the fixed shower.

The handheld shower is composed of a handle and a shower head extended from one end of the handle. The handle is connected to the second water outlet of the diverter. The shower head is provided with a water outlet panel on a front side and a fixing base located at a rear side for detachably connection to the second connection portion of the fixing bracket.

The handheld shower is fixed on a fixing bracket, instead of directly fixed on the fixed shower. Thus water spray area of the fixed shower is not occupied too much. The amount of water sprayed out and the water spray area of the fixed shower are ensured to meet water demands for the overhead shower bath. At the same time, the handheld shower can also provide sufficient amount of water sprayed out and water spray area.

The handheld shower is designed to be fixed on the fixing bracket, instead of the fixed shower. Thus the users can take the handheld shower from the fixing bracket, operate or install the handheld shower more flexibly, without obstruction or interference from the fixed shower. The installation, detachment or release of the handheld shower is easier, faster, and smoother.

The handheld shower is designed to be fixed on the fixing bracket. Once the fixing bracket is damaged or out of order, only the fixing bracket needs to be replaced. Moreover, the fixing bracket has simple structure without being involved in any water channels and thus easy to be assembled and disassembled. Thereby replacement cost is lower and the replacement is easy so that users can replace the fixing bracket by themselves.

### BRIEF DESCRIPTION OF THE DRAWINGS

FIG. 1 is a perspective view of an embodiment according to the present invention;

FIG. 2 is a longitudinal sectional view of an embodiment according to the present invention;

FIG. 3 is an exploded view of an embodiment according to the present invention;

FIG. 4 is a front view of an embodiment according to the present invention;

FIG. 5 is a longitudinal sectional view of a fixed shower according to the present invention;

FIG. 6 is another perspective view of an embodiment viewed from a back side according to the present invention.

### DETAILED DESCRIPTION

Please refer to the following embodiment combined with related figures for further description.

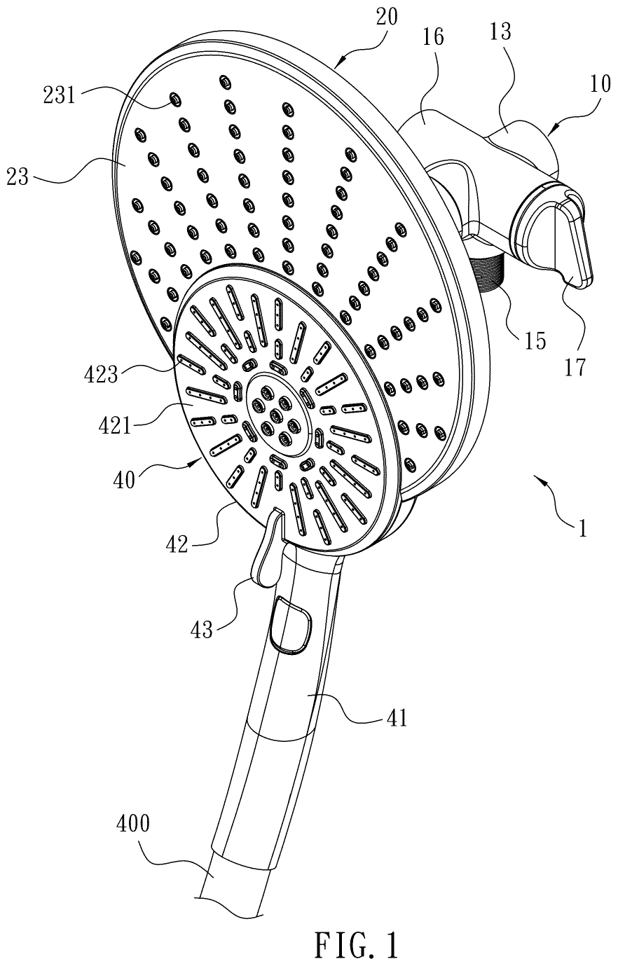

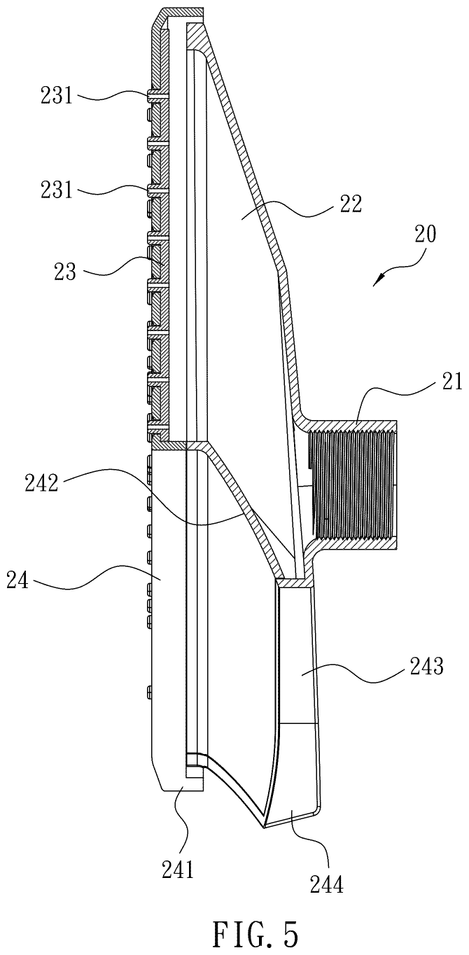

Refer to FIGS. 1-6, a preferred embodiment of a dual-function shower apparatus according to the present invention is provided. A dual-function shower apparatus 1 according to the present invention includes a diverter 10, a fixed shower 20, a fixing bracket 30, and a handheld shower 40.

The diverter 10 is directly or indirectly fixed on a wall and able to be operated for directing water flowing through to a first water outlet 11 or a second water outlet 12.

The fixed shower 20 consists of a water inlet joint 21 located at a back side and used for connection with the first water outlet 11, an internal cavity 22 communicating with the water inlet joint 21, a spray panel 23 located at a front side and communicating with the internal cavity 22, and a mounting recess 24 located at a first side of the spray panel 23. The mounting recess 24 is provided with a first notch 241 formed at the first side, a bottom wall 242, a trough opening 243 formed on the bottom wall 242 and located at the first side, and a second notch 244 formed on the trough opening 243 and located at the first side. A width of the second notch 244 is smaller than a width of the first notch 241. In this embodiment, the first side is the bottom side, but not limited. The first side can also be a left side, a right side, a lower left side, a lower right side of the spray panel 23, or other positions suitable for installation. In this embodiment, the water inlet joint 21 is connected with the first water outlet 11 by thread engagement, but not limited. Other common ways for connection such as mounting, adhesion, etc. can also be used.

The fixing bracket 30 is provided with a first connection portion 31 and a second connection portion 32 connected to the first connection portion 31. The first connection portion 31 is for connection to the diverter 10 and the second connection portion 32 is mounted to the trough opening 243 of the fixed shower 20.

The handheld shower 40 is composed of a handle 41 and a shower head 42 extended from one end of the handle 41. The handle 41 can be connected to the second water outlet 12 of the diverter 10. The shower head 42 is provided with a water outlet panel 421 on a front side and a fixing base 422 located at a rear side for detachably connection to the second connection portion 32 of the fixing bracket 30.

In this embodiment, as shown in FIG. 1, a plurality of first nozzles 231 is formed on the spray panel 23 of the fixed shower 20 for spraying the water with a first spray pattern. The water outlet panel 421 of the handheld shower 40 is provided with a plurality of second nozzles 423 for spraying the water with a second spray pattern. The first spray pattern and the second spray pattern respectively provide users overhead shower experience and a handheld shower bath.

The second nozzles 423 of the handheld shower 40 can be arranged at a peripheral area to form a peripheral spray pattern or disposed on a central area to form a central spray pattern. The peripheral spray pattern and the central spray pattern can be switched by a knob 43. The structure and operation of the knob 43 are prior arts and not repeated herein.

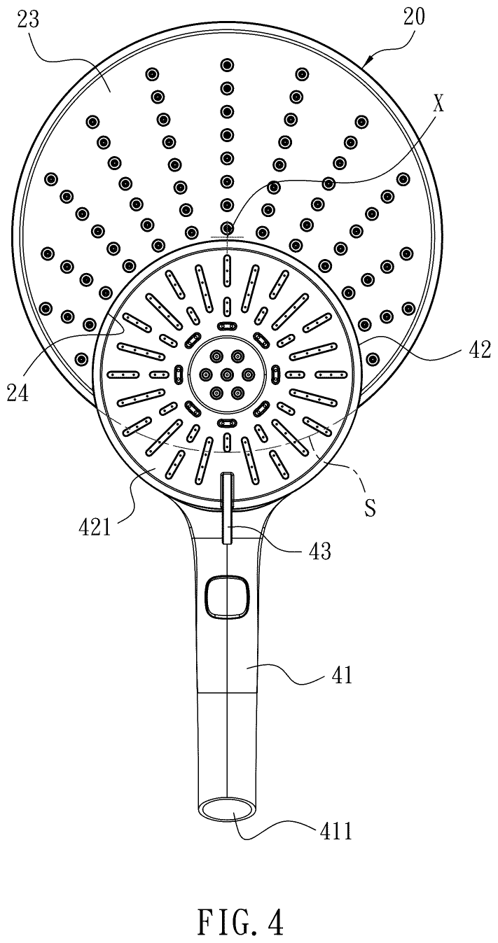

As shown in FIG. 4, in this embodiment, the fixed shower 20 is provided with a virtual axis X and the mounting recess 24 is located at an area outside the virtual axis X (area without covering the virtual axis X). In other words, the spray panel 23 of the fixed shower 20 is designed to be in a disc shape without a lower area which is used to form the mounting recess 24. Owing to the lost area, the spray panel 23 looks like a crescent. The virtual axis X is basically defined on the disc shape. The mounting recess 24 is located at the area outside the virtual axis X such as the lower area, without covering the virtual axis X. This represents a smaller ratio of an area of the mounting recess 24 to a whole area of the spray panel 23. The above structural design can ensure sufficient water spray area of the spray panel 23 of the fixed shower 20, which means more first nozzles 231 are able to be distributed on the spray panel 23 for larger amount of the water sprayed or larger water spray area. Thereby user's needs for an overhead shower bath can be met.

It could see that the spray panel 23 is not limited to the disc shape, it may be in other shapes which are basically able to be defined to a central point similar to the axis X. And the position and the area ratio of the mounting recess 24 with respect to the spray panel 23 are about the same as those mentioned above.

In this embodiment, the spray panel 23 of the fixed shower 20 has a first area and the water spray panel 421 of the handheld shower 40 has a second area while the second area is significantly smaller than the first area. According to the above design, it is ensured that the water spray panel 421 can be mounted in or compatible with the fixed shower 20 or located adjacent to the spray panel 23 with a smaller ratio of the area. Thus a water spray area of the spray panel 23 is not limited and reduced and there is no need to increase the size (area) of the spray panel 23. It can be understood that a radius of the water spray panel 421 is obviously smaller than a radius of the spray panel 23 once both the spray panel 23 and the water spray panel 421 are designed into the disc shape.

In this embodiment, as shown in FIG. 4, the spray panel 23 of the fixed shower 20 constructs a virtual peripheral line S at the mounting recess 24. The water spray panel 421 of the handheld shower 40 is over the peripheral line S. In other words, only a part of the water spray panel 421 is within the peripheral line S while the rest part is designed to be over the peripheral line S of the fixed shower 20. The above design ensures not only sufficient water spray area of the spray panel 23 of the fixed shower 20, but also ensures sufficient water spray area of the water spray panel 421 of the handheld shower 40. That means both the fixed shower 20 and the handheld shower 40 have sufficient amount of water sprayed out and adequate water spray area.

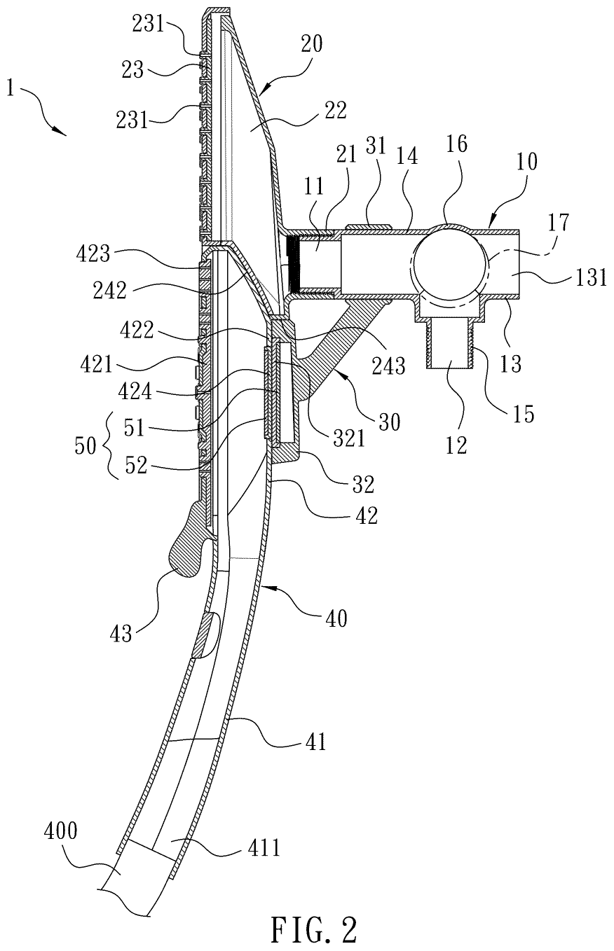

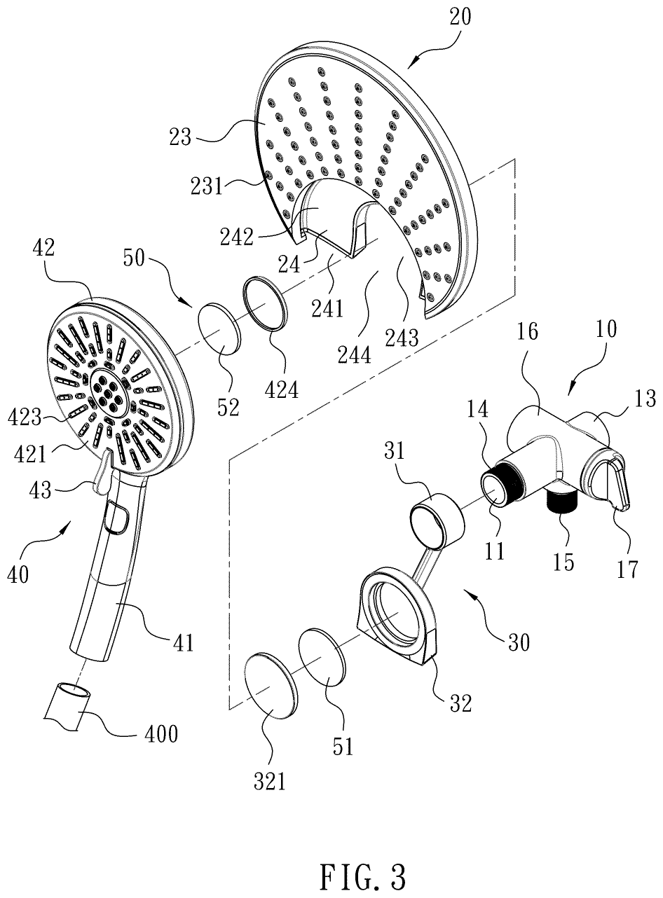

As shown in FIG. 2 and FIG. 3, the diverter 10 is provided with a water inlet pipe 13, a first water outlet pipe 14, a second water outlet pipe 15, and a valve pipe 16 having one end connected to and located among the water inlet pipe 13, the first water outlet pipe 14 and the second water outlet pipe 15. A water inlet 131 is formed on an outer end of the water inlet pipe 13 for allowing the water to flow in. The first water outlet 11 and the second water outlet 12 are respectively formed on an outer end of the first water outlet pipe 14 and an outer end of the second water outlet pipe 15. A valve assembly 17 is mounted in the valve pipe 16 and able to be manually operated for switching a flow of the water into the first water outlet 11 or the second water outlet 12. The first connection portion 31 of the fixing bracket 30 is designed into a sleeve for being mounted around and fixed on the first water outlet pipe 14 of the diverter 10. A water intake port 411 is formed on an outer end of the handle 41 of the handheld shower 40 for connection to one end of a hose 400 while the other end of the hose 400 is connected to the second water outlet 12.

When a water flow supplied flows through water pipelines inside the walls and enters the diverter 10 through the water inlet 131, users can operate the valve assembly 17 manually for switching the water flow to the first water outlet 11 and further to the fixed shower 20 or switching the water flow to the second water outlet 12 and further to the handheld shower 40 through the hose 400.

In this embodiment, a magnetic attachment member 50 is disposed between the second connection portion 32 of the fixing bracket 30 and the fixing base 422 of the handheld shower 40 so that the second connection portion 32 and the fixing base 422 are attached together while getting closer to each other or separated from each other while being applied with forces and operated.

To be more specific, as shown in FIG. 2 and FIG. 3, the magnetic attachment member 50 consists of a first magnetic part 51 and a second magnetic part 52. The first magnetic part 51 is disposed on the second connection portion 32 of the fixing bracket 30 and the second magnetic part 52 is arranged at the fixing base 422 of the handheld shower 40 and magnetically attached to the first magnetic part 51. It is easily understandable that the first magnetic part 51 and the second magnetic part 52 can be both magnets or one of them is a magnet while the other is a metal part able to be magnetically attached by the magnet.

The first magnetic part 51 is able to be mounted in the second connection portion 32 and covered and sealed by a first cover 321. Similarly, the second magnetic part 52 is also mounted in the fixing base 422 and covered and sealed by a second cover 424.

It should be noted that the second connection portion 32 of the fixing bracket 30 and the fixing base 422 of the handheld shower 40 are not limited to be connected by the magnetic attachment member 50. They can also be designed to be connected by a mechanical connector able to be operated and detached such as fasteners, hook-and-eye, and buckles as long as users can separate the second connection portion 32 and the fixing base 422 conveniently.

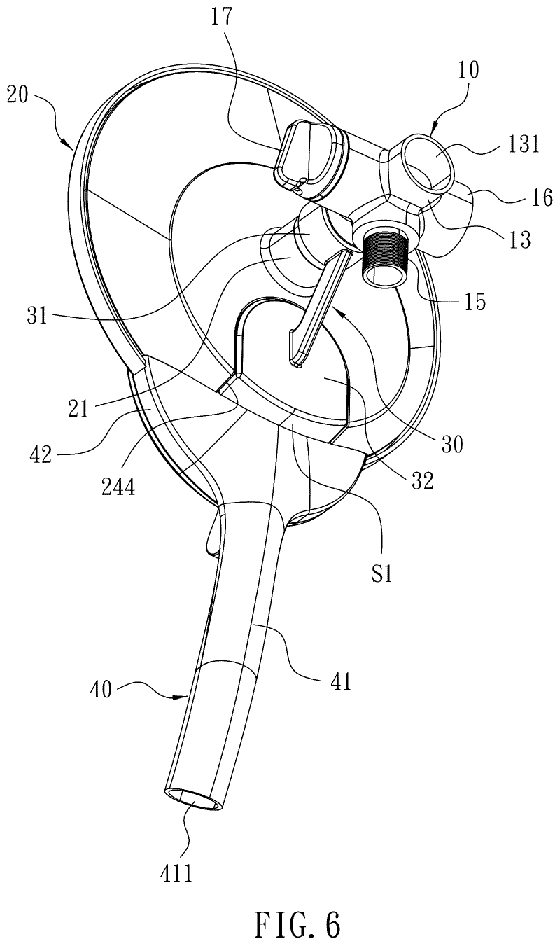

In this embodiment, the second connection portion 32 of the fixing bracket 30 is mounted in and perfectly matched to the trough opening 243 of the fixed shower 20. As shown in FIG. 6, a part of an outline S1 of the second connection portion 32 is completely filled in the second notch 244 of the trough opening 243. In other words, viewed from a back side of the fixed shower 20, the second connection portion 32 is perfectly matched to the fixed shower 20 to keep integrity and aesthetics of visual appearance in a non-obtrusive manner.

It should be noted that the spray panel 23 of the fixed shower 20 and the water spray panel 421 of the handheld shower 40 should be designed to be at the same plane or nearly at the same plane.

In summary, the dual-function shower apparatus of the present invention includes the following features and functions.

The handheld shower 40 is fixed on the fixing bracket 30, instead of being directly fixed on the fixed shower 20. The mounting recess 24 of the fixed shower 20 is mainly used as an avoidance space for mounting the handheld shower 40. Thus the water spray area of the fixed shower 20 is not occupied too much. The amount of water sprayed out and the water spray area of the fixed shower 20 are ensured to meet water demands for the overhead shower bath. At the same time, the handheld shower 40 can also provide sufficient amount of water sprayed out and water spray area.

Instead of being directly fixed on the fixed shower 20, the handheld shower 40 is designed to be fixed on the fixing bracket 30. Thus the users can take the handheld shower 40 from the fixing bracket 30, operate or install the handheld shower 40 easily and smoothly, without obstruction or interference from the fixed shower 20. The installation or detachment of the handheld shower 40 is easier, faster, and smoother.

The handheld shower 40 is designed to be fixed on the fixing bracket 30. Once the fixing bracket 30 is damaged or out of order, only the fixing bracket 30 needs to be replaced. Moreover, the fixing bracket 30 has simple structure without being involved in any water channels and thus easy to be assembled and disassembled. Thereby replacement cost is lower and the replacement is easy so that users can replace the fixing bracket 30 by themselves.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A dual-function shower apparatus comprising:
a diverter connected and fixed on a wall and able to be operated for directing water flowing through to a first water outlet or a second water outlet;
a fixed shower including a water inlet joint located at a back side for connection with the first water outlet, an internal cavity communicating with the water inlet joint, a spray panel located at a front side and communicating with the internal cavity, and a mounting recess located at a first side of the spray panel; the mounting recess provided with a first notch formed at the first side, a bottom wall, a trough opening formed on the bottom wall and located at the first side, and a second notch formed on the trough opening and located at the first side; a width of the second notch smaller than a width of the first notch;
a fixing bracket provided with a first connection portion and a second connection portion connected to the first connection portion; the first connection portion used for connection to the diverter and the second connection portion being mounted to the trough opening of the fixed shower; and
a handheld shower having a handle and a shower head extended from one end of the handle; the handle used for connection to the second water outlet of the diverter; the shower head provided with a water outlet panel on a front side and a fixing base located at a rear side for detachably connection to the second connection portion of the fixing bracket.

2. The dual-function shower apparatus as claimed in claim 1, wherein a plurality of first nozzles is formed on the spray panel of the fixed shower for spraying the water with a first spray pattern; the water outlet panel of the handheld shower is provided with a plurality of second nozzles for spraying the water with a second spray pattern.

3. The dual-function shower apparatus as claimed in claim 1, wherein the fixed shower is provided with a virtual axis and the mounting recess is located at an area which is outside the virtual axis, without covering the virtual axis.

4. The dual-function shower apparatus as claimed in claim 1, wherein the spray panel of the fixed shower has a first area and the water spray panel of the handheld shower has a second area while the second area is significantly smaller than the first area.

5. The dual-function shower apparatus as claimed in claim 1, wherein the spray panel of the fixed shower forms a virtual peripheral line at the mounting recess; the water spray panel of the handheld shower is over the peripheral line.

6. The dual-function shower apparatus as claimed in claim 1, wherein the diverter includes a water inlet pipe, a first water outlet pipe, a second water outlet pipe, and a valve pipe connected to and located among the water inlet pipe, the first water outlet pipe, and the second water outlet pipe; a water inlet is formed on an outer end of the water inlet pipe for allowing the water to flow in; the first water outlet and the second water outlet are respectively formed on an outer end of the first water outlet pipe and an outer end of the second water outlet pipe; a valve assembly is mounted in the valve pipe and able to be manually operated for switching a flow of the water into the first water outlet or the second water outlet; wherein the first connection portion of the fixing bracket is a sleeve for being mounted around and fixed on the first water outlet pipe of the diverter; wherein a water intake port is formed on an outer end of the handle of the handheld shower for connection to one end of a hose while the other end of the hose is connected to the second water outlet.

7. The dual-function shower apparatus as claimed in claim 1, wherein a magnetic attachment member is disposed between the second connection portion of the fixing bracket and the fixing base of the handheld shower so that the second connection portion and the fixing base are attached together while getting closer to each other or separated from each other while being applied with forces.

8. The dual-function shower apparatus as claimed in claim 7, wherein the magnetic attachment member consists of a first magnetic part and a second magnetic part; the first magnetic part is disposed on the second connection portion of the fixing bracket; the second magnetic part is arranged at the fixing base of the handheld shower and magnetically attached to the first magnetic part.

9. The dual-function shower apparatus as claimed in claim 8, wherein the first magnetic part and the second magnetic part are both magnets.

10. The dual-function shower apparatus as claimed in claim 8, wherein the first magnetic part is one of a magnet and a metal part while the second magnetic part is the other of the magnet and the metal part.

11. The dual-function shower apparatus as claimed in claim 1, wherein a mechanical connector able to be operated and detached is arranged between the second connection portion of the fixing bracket and the fixing base of the handheld shower.

12. The dual-function shower apparatus as claimed in claim 1, wherein the second connection portion of the fixing bracket is mounted in and perfectly matched to the trough opening of the fixed shower; a part of an outline of the second connection portion is completely filled in the second notch of the trough opening.
